(19) United States
(12) Patent Application Publication
(10) Pub. No.: US 2024/0147896 A1
(43) Pub. Date: May 9, 2024

(54) SYSTEM AND METHOD FOR APPLYING AMENDMENT

(71) Applicant: HALTER USA INC., San Francisco, CA (US)

(72) Inventors: Aaron John Traynor, Hamilton (NZ); Steve Crowhurst, Raglan (NZ); Carlos Eduardo De Souza Garbiatti, Auckland (NZ)

(21) Appl. No.: 18/509,532

(22) Filed: Nov. 15, 2023

Related U.S. Application Data
(63) Continuation-in-part of application No. PCT/IB2022/054555, filed on May 17, 2022.

(30) Foreign Application Priority Data
May 17, 2021 (AU) 2021901464
Aug. 24, 2021 (AU) 2021221482
Feb. 24, 2022 (AU) 2022900436

(51) Int. Cl. A01C 21/00; A01B 79/00; G06Q 50/02

(52) U.S. Cl. CPC A01C 21/007; A01B 79/005; G06Q 50/02

(57) ABSTRACT

A system and method to allow precise control of amendments to soil or pasture is disclosed. Current amendment systems may add too much or the wrong type of amendment to pasture, for example on locations high in animal waste, therefore leading to environmental risks. The system includes a wearable device to be worn by an animal. The wearable device is able to determine at least one of the location of an animal, and activity of the animal, such as urinating. This information is modified by a series of steps, and then uploaded or communicated to an amendment applicator to selectively apply an amendment to a pasture appropriately depending on the received animal information.

### CROSS-REFERENCE TO RELATED APPLICATION(S)

This application claims priority to and is a bypass continuation-in-part application of International Application No. PCT/IB2022/054555, entitled “SYSTEM AND METHOD FOR APPLYING AMENDMENT”, filed May 17, 2022; which claims priority to Australian Application No. 2022900436, entitled “SYSTEM AND METHOD FOR APPLYING AMENDMENT”, filed Feb. 24, 2022, Australian Application No. 2021221482, entitled “SYSTEM AND METHOD FOR APPLYING AMENDMENT”, filed Aug. 24, 2021, and Australian Application No. 2021901464, entitled “SYSTEM AND METHOD FOR APPLYING AMENDMENT”, filed May 17, 2021; the contents of each being incorporated by reference herein in its entirety.

### FIELD OF THE INVENTION

The present invention relates to a system and method for applying amendment. More particularly but not exclusively it relates to a system and method for applying amendment to pasture, crop or soil by determining the activity type of a grazing animal and/or time a grazing animal spends at a location.

### BACKGROUND OF THE INVENTION

Animal waste such as excrement and urine may comprise a lot of nutrients that are beneficial or detrimental to crops, such as brassicas, pasture, grasses etc. In particular, the nutrients may be beneficial or detrimental to pasture for grazing animals such as bovine, e.g. beef and cows. Typically, animals are likely to defecate or urinate where they spend more time, e.g. where they camp out. Further, as grazing animals roam around a paddock, they deposit excreta onto the pasture at certain areas where they urinate and defecate.

Currently, to take advantage of these nutrients, farmers may spread pre-collected waste over paddocks (which contain pasture) as fertiliser. This may be achieved via irrigation systems or via moveable or drivable spreaders. However, this requires substantial infrastructure, collection of waste. Also, such traditional approaches do not deal with waste that is deposited directly from the animal to the paddock.

Farmers may also add traditional fertilizers or amendments to pasture. Such fertilizer may be nitrogen. Nitrogen is the primary nutrient most commonly needed for grasses, other fertilizers, such as phosphorus, potassium, or sulfur, also may be deficient in the pasture and needed for increased pasture growth. Further, farmers may want to apply amendments onto a pasture to neutralize or reduce the effects of the animal waste. For example, a urease inhibitor may be applied to an area where a cow has urinated.

If the farmer adds a pasture amendment to an area where an animal has defecated or urinated, then a problem of over fertilizing or having an excess of a certain compound, fertilizer, or amendment may occur. One way of overcoming this is by the farmer guessing where the animals may camp out, e.g. under a tree, and use this information to not apply an amendment in said area. This requires a lot of guesswork, or a constant surveillance of where the animals are camping. However, animals may also roam a paddock and defecate or urinate in areas outside of a typical camp.

One solution that has been trialed to rescue waste effects is to spot spray areas where a cow has urinated or defecated with an amendment to neutralize or reduce the effects of the animal waste. This is done by running a machine over the pasture and detecting where recent urine spots are, by detecting conductivity. This requires a machine to be physically present in the paddock and run over all ground to have amendment potentially added to. Further it requires the machine to be present in the paddock shortly after the animals have been in the paddock, so the conductivity differential is still present. In one example the machine is a specialised sprayer towed by a tractor driven by a worker. This solution may be expensive, labour intensive, and time sensitive.

### SUMMARY OF THE INVENTION

It is an object of the present invention to provide a system and method for applying amendment that overcomes or at least partially ameliorates some of the abovementioned disadvantages or which at least provides the public with a useful choice.

In a first aspect, the invention resides in a method of applying an amendment to at least one of crop, pasture and soil within a zone, wherein the method comprises at least the following steps:
a. determining a zone map of the zone which is to have amendment applied to or within, the zone map comprising information on a desired amount of the amendment and/or type of amendment to be applied to said at least one of crop, pasture and soil within the zone,
b. determining at least one of:
   i. location information comprising a duration of time spent by at least one animal in a particular location within said zone over a period of time, and
   ii. position information corresponding to the activity of at least one animal within said zone at a particular location,
c. processing at least one of the location information and the position information determined from at least one of i and ii and creating a heat map representing at least one of the location information and the position information of said at least one animal,
d. applying a factor index to the heat map to create a modified heat map, the factor index comprising at least one factor to change the amount of the amendment and/or type of amendment to be applied, the modified heat map comprising factors to change said at least one of the location information and the position information into a processed data for determining the amount and/or the type of the amendment to be applied to at least the particular locations in the zone,
e. using modified heat map to create an application map, the application map being used to determine the location, amount, and optionally type, of the amendment to be applied to the particular locations within the zone, and
f. applying the amount and type of amendments to said at least one of crop, pasture and soil dependent on the application map.

In one embodiment, the steps a-e are performed on a computer.

In one embodiment, the activity is at least one of urination, defecation, grazing, ruminating, standing, walking, running, resting, lying, birthing and mating.

In one embodiment, the factor index is predetermined depending on the type of amendment.

In one embodiment, the factor index is predetermined by the user, in alternative embodiments, the factor index is predetermined by the computer.

In one embodiment, the factor index is predetermined depending on the type of amendment.

In one embodiment, the factor index comprises a first factor to increase the amount of amendment to the particular location(s) of the zone depending on the heat map.

In one embodiment, the factor index comprises a second factor to increase the amount of amendment depending on the heat map where said at least one animal has spent less time compared to elsewhere within the zone, or has less activity than elsewhere within the zone.

In one embodiment, the factor index comprises a third factor to increase an amount of fertiliser depending on the heat map where said at least one animal has spent less time compared to elsewhere within the zone, or has less activity than elsewhere within the zone.

In one embodiment, the factor index comprises a fourth factor to decrease the amount of amendment depending on the heat map.

In one embodiment, the factor index comprises a fifth factor to decrease the amount of amendment depending on the heat map where said at least one animal has spent more time compared to elsewhere within the zone, or has more activity than elsewhere within the zone.

In one embodiment, the factor index comprises a sixth factor to decrease an amount of fertilizer depending on the heat map where said at least one animal has spent more time compared to elsewhere within the zone, or has more activity than elsewhere within the zone.

In one embodiment, the factor index comprises a seventh factor to change the amount of amendment and/or select the type of amendment depending on the heat map.

In one embodiment, the factor index comprises an eighth factor to change the amount of amendment and/or select the type of amendment depending on the heat map where the at least one animal has spent more time compared to elsewhere within the zone, or has more activity than elsewhere within the zone.

In one embodiment, the factor index comprises a ninth factor to add a further amendment alongside another amendment depending on the heat map.

In one embodiment, the factor index comprises a tenth factor to add a further amendment alongside another amendment depending on the heat map where the said at least one animal has spent more time compared to elsewhere within the zone, or has more activity than elsewhere within the zone.

In one embodiment, the factor index comprises an eleventh factor to change the amount of urease inhibitor and/or select a type of urease inhibitor depending on the heat map.

In one embodiment, the factor index comprises a twelfth factor to change the amount of urease inhibitor and/or select the type of urease inhibitor depending on the heat map where the said at least one animal has spent more time compared to elsewhere within the zone, or has more urination activity than elsewhere within the zone.

In one embodiment, the factor index comprises a thirteenth factor to change the amount of fertiliser and/or select the type of fertilizer depending on the heat map.

In one embodiment, the factor index comprises a fourteenth factor to change the amount of fertiliser and/or select the type of fertilizer depending on the heat map where said at least one animal has spent less time compared to elsewhere within the zone, or has less activity than elsewhere within the zone.

In one embodiment, the factor index comprises a fifteenth factor to select an amendment to decrease negative effects of high nitrogen content caused by said at least one animal's urine and/or excrement.

In one embodiment, the application map is configured to be received by an amendment applicator that is configured to release the amount and/or type of amendment as an amendment output.

In one embodiment, the amendment applicator is a variable rate fertiliser spreader, seeder, planter, and/or sprayer.

In one embodiment, the amendment output is controllable by software.

In one embodiment, the software is configured to use the amendment map for controlling the amendment output.

In one embodiment, a total duration of time spent by said at least one animal in said particular location is used to create a heat map.

In one embodiment, the method comprises the step of determining at least one of the location information and position information using a wearable device, wherein the wearable device comprises at least one of a navigation module and a position sensing device.

In one embodiment, the wherein the position sensing device comprises one or more of, GPS module, an accelerometer, IMU, and magnetometer, and/or other features configured to aid in determining the activity information or location information relating to the activity and/or location of an said at least one animal.

In one embodiment, the location information and/or the angular position information is configured to be sent from the wearable device to a server.

In one embodiment, the location information and/or the position information is recorded as data points by the wearable device.

In one embodiment, the server is a computer, server, or cloud server for use in creating the heat map.

In one embodiment, the location information and/or the position information recorded at intermittent time periods.

In one embodiment, a value of a particular location is the total number of data points.

In one embodiment, the total number of data points is aggregated by the wearable device over an aggregation time period, and/or the aggregation time period is between 30 seconds and 1 hour.

In one embodiment, the location information is time spent by said at least one animal at said particular location over a set period of time and/or over the aggregation time period, or number of times said at least one animal has been recorded at said particular location over a set period of time and/or over the aggregation time period.

In one embodiment, the method comprises the step of utilising the data points recorded over a set period of time for creation of the heat map.

In one embodiment, the set period of time comprises multiple aggregation time periods.

In one embodiment, the set period of time is determined by the user.

In one embodiment, the period of time is a period of time between 3 minutes and 5 years.

In one embodiment, the method comprises the step of indexing the zone map and/or heat map for a geo-index comprising geo-index areas.

In one embodiment, the particular location(s) of the zone are the geo-index areas.

In one embodiment, the method comprises the step of assigning the geo-indexed area the value relating to location information and/or position information recorded as being within the geo-index area.

In one embodiment, the method comprises the step of determining a key-value structure, where the key is the geo-index and the value is or relates to how many data points were found inside said geo-index area for the set period of time.

In one embodiment, the zone map is indexed for a geo-index.

In one embodiment, a heat map is indexed for a geo-index.

In one embodiment, the geo-index is the H3 geo-index.

In one embodiment, the H3 geo-index is resolution 13.

In one embodiment, a zone map comprises information on a selection of wearable devices.

In one embodiment, the selection of wearable devices is worn by a respective herd of animals.

In one embodiment, a geo-index location is paired with the location information over a period of time.

In one embodiment, the pairing of geo-index location with location information over a period of time is the heat map.

In one embodiment, the value of a geo-indexed location is the number of times a data point relating to an animal location is recorded as being within the geo-indexed location.

In one embodiment, the data points from the animal are taken over a time period.

In one embodiment, the time period is three minutes.

In one embodiment, the heat map is made up of the said values per geo-index.

In one embodiment, the method comprises the step of determining the location and/or position information of multiple wearable devices.

In one embodiment, the at least one wearable device comprises one or more of a LoRa® module, a WiFi® module, and/or a radio module to communicate with the server.

In a further aspect, the invention resides in a method of applying an amendment to at least one of crop, pasture and soil within a zone, wherein the method comprises at least the following steps:
a. determining a zone map of the zone which is to have amendment applied to or within, the zone map comprising information on a desired amount of the amendment and/or type of amendment to be applied to said at least one of crop, pasture and soil within the zone,
b. determining at least one of:
   i. a location information relating to time spent by at least one animal in a particular location within said zone over a period of time, and
   ii. a position information corresponding to the activity of at least one animal within said zone over a period of time and
c. processing at least one of the location information and the angular position information determined from at least one of i and ii and creating a heat map representing at least one of the location and the activity of said at least one animal,
d. applying a factor index to the heat map to create a modified heat map, the factor index comprising at least one factor to change the amount of the amendment and/or type of amendment to be applied, the modified heat map comprising factors to change said at least one of the location information and the angular position information into a processed data for determining the amount and/or the type of the amendment to be applied, and
e. using the zone map and modified heat map to create an application map, the application map being used to determine the location, type, and amount of the amendment to be applied within the zone,
f. applying the amount and type of amendments to said at least one of crop, pasture and soil dependent on the application map.

In one embodiment, the zone map is indexed for a geo-index.

In one embodiment, a heat map is indexed for a geo-index.

In one embodiment, the geo-index is the H3 geo-index.

In one embodiment, the H3 geo-index is resolution 13.

In one embodiment, a zone map comprises information on a selection of wearable devices.

In one embodiment, the selection of wearable devices is worn by a respective herd of animals.

In one embodiment, a geo-index location is paired with the location information over a period of time.

In one embodiment, the pairing of geo-index location with location information over a period of time is the heat map.

In one embodiment, the embodiments relating to the first aspect of the invention also relate to the present aspect.

In one embodiment, the value of a geo-indexed location is the number of times a data point relating to an animal location is recorded as being within the geo-indexed location.

In one embodiment, the data points from the animal are taken over a time period.

In one embodiment, the time period is three minutes.

In one embodiment, the heat map is made up of the said values per geo-index.

In one embodiment, the method comprises a step of affixing a wearable device configured to be worn by an animal, the wearable device comprising:
a. a processor, and
b. at least one of:
   1. a navigation module to aid in determining location information of the animal and a time said at least one animal has spent in said particular location, and
   2. at least one position sensing device selected from a gyroscope, accelerometer, IMU, and magnetometer to sense the position of the animal corresponding to the activity of said at least one animal to determine activity information of said at least one animal.

In one embodiment, the time spent at said particular location is the cumulative time spent by said at least one animal at said location over a set period of time.

In one embodiment, the set period of time is the amount of time said at least one animal is located in a paddock.

In one embodiment, said at least one animal is a grazing animal.

In one embodiment, said at least one animal is a bovine.

In one embodiment, the embodiments relating to the first aspect of the invention also relate to the present aspect.

In a further aspect, the invention resides in a system for applying an amendment to at least one of crop, pasture and soil within a zone, the system comprising:
a. a wearable device configured to be worn by an animal, the wearable device comprising
   a processor, and
   at least one of:
      a navigation module to aid in determining location information of the animal at a respective time, optionally a time said at least one animal has spent in said particular location, and
      at least one position sensing device selected from a gyroscope, accelerometer, IMU, and magnetometer to sense the position of the animal corresponding to the activity of said at least one animal to determine activity information of said at least one animal,
b. a computer that is in operative communication with the wearable device, the computer being configured to:
   i. receive a zone map of a zone which is to have amendment applied to or within, the zone map comprising information of a desired application amount of the amendment and/or type of amendment to be applied to said at least one of crop, pasture and soil within the zone,
   ii. receive a location information comprising a particular location of the animal and a duration of time spent by at least one animal in the particular location within said zone over a period of time and/or a position information corresponding to the activity of at least one animal within said zone over a period of time
   iii. process at least one of the location information and the position information and creating a heat map representing at least one of the location and the activity of said at least one animal,
   iv. apply a factor index to the heat map to create a modified heat map, the factor index comprising at least one factor to change the amount of the amendment and/or type of amendment to be applied, the modified heat map comprising factors to change the at least one of the location information and the angular position information into a processed data for determining the amount and/or the type of the amendment to be applied,
   v. use the zone map and modified heat map to create an application map for determining the location, type, and amount of the amendment to be applied within the zone, and
   vi. use the application map to determine the location, type, and amount of the amendment to be applied within the zone.

In one embodiment, the embodiments relating to the first aspect of the invention also relate to the present aspect.

In one embodiment, the system comprises an amendment applicator that is in operative communication with the computer that is configured to receive information that is determined using the application map and apply the appropriate amendment type and amount to the pasture based on the determined information.

In one embodiment, the system comprises multiple wearable devices.

In one embodiment, the computer is configured to overlay the location information of multiple animals, from multiple respective wearable devices to create the heat map.

In one embodiment, the computer is configured to overlay the activity information of multiple animals from multiple respective wearable devices to create the heat map.

In one embodiment, the computer is configured to combine the location information and activity information to create the heat map.

In one embodiment, the factor index is configured to apply a weighting to the activity information to affect the weighting of the activity information on the heat map.

In one embodiment, the weighting of an animal activity information relating to the animal when resting or stationary has more weighting on the heat map compared to an animal when moving.

In one embodiment, the weighting of an animal activity information relating to the animal when urinating or defecating has more weighting on the heat map compared to an animal when moving.

In one embodiment, the system comprises a variable rate spreader configured to receive the application map, and apply amendment to the zone according to the application map.

In a further aspect, the invention relates to a method of applying an amendment to at least one of crop, pasture and soil within a zone, wherein the method comprises at least the following steps:
determining a zone map of the zone which is to have amendment applied to or within, the zone map comprising information on a desired amount of the amendment and/or type of amendment to be applied to said at least one of crop, pasture and soil within the zone,
determining at least one of:
   i. a location information comprising a duration of time spent by at least one animal in a particular location within said zone over a period of time, and
   ii. a position information corresponding to the activity of at least one animal within said zone over a period of time and
processing at least one of the location information and the angular position information determined from at least one of i and ii and creating a heat map representing at least one of the location and the activity of said at least one animal,
applying a factor index to the heat map to create a modified heat map, the factor index comprising at least one factor to change the amount of the amendment and/or type of amendment to be applied, the modified heat map comprising factors to change said at least one of the location information and the angular position information into a processed data for determining the amount and/or the type of the amendment to be applied, and
using the zone map and modified heat map to create an application map, the application map being used to determine the location, type, and amount of the amendment to be applied within the zone.

In one embodiment, the method further includes the step of applying the amount and type of amendments to said at least one of crop, pasture and soil dependent on the application map.

In one embodiment, the system comprises a variable rate spreader configured to receive the application map, and apply amendment to the zone according to the application map.

In a further embodiment, the invention resides in a system for applying an amendment to at least one of crop, pasture and soil within a zone, the system comprising a computer that is in operative communication with a wearable device configured to be worn by an animal, the wearable device comprising
a processor, and
at least one of:
   a navigation module to aid in determining location information of the animal and a time said at least one animal has spent in said particular location, and
   at least one position sensing device selected from a gyroscope, accelerometer, IMU, and magnetometer to sense the position of the animal corresponding to the activity of said at least one animal to determine activity information of said at least one animal,
the computer being configured to:
   i. receive a zone map of a zone which is to have amendment applied to or within, the zone map comprising information of a desired application amount of the amendment and/or type of amendment to be applied to said at least one of crop, pasture and soil within the zone,
   ii. receive a location information comprising a particular location of the animal and a duration of time spent by at least one animal in the particular location within said zone over a period of time and/or a position information corresponding to the activity of at least one animal within said zone over a period of time
   iii. process at least one of the location information and the position information and creating a heat map representing at least one of the location and the activity of said at least one animal,
   iv. apply a factor index to the heat map to create a modified heat map, the factor index comprising at least one factor to change the amount of the amendment and/or type of amendment to be applied, the modified heat map comprising factors to change the at least one of the location information and the angular position information into a processed data for determining the amount and/or the type of the amendment to be applied,
   v. use the zone map and modified heat map to create an application map for determining the location, type, and amount of the amendment to be applied within the zone, and
   vi. use the application map to determine the location, type, and amount of the amendment to be applied within the zone.

The embodiments of the first aspect may also relate to this aspect.

In a further embodiment, the invention resides in a system for applying an amendment to at least one of crop, pasture and soil within a zone, the system comprising at least one processor that is configured to:
use navigation information to determine location information of the animal and a time said at least one animal has spent in a particular location, and
use position sensing information to determine the position of the animal corresponding to the activity of said at least one animal to determine activity information of said at least one animal,
said at least one processor being further configured to:
i. receive a zone map of a zone which is to have amendment applied to or within, the zone map comprising information of a desired application amount of the amendment and/or type of amendment to be applied to said at least one of crop, pasture and soil within the zone,
ii. receive a location information comprising a particular location of the animal and a duration of time spent by at least one animal in the particular location within said zone over a period of time and/or a position information corresponding to the activity of at least one animal within said zone over a period of time,
iii. process at least one of the location information and the position information and creating a heat map representing at least one of the location and the activity of said at least one animal,
iv. apply a factor index to the heat map to create a modified heat map, the factor index comprising at least one factor to change the amount of the amendment and/or type of amendment to be applied, the modified heat map comprising factors to change the at least one of the location information and the angular position information into a processed data for determining the amount and/or the type of the amendment to be applied,
v. use the zone map and modified heat map to create an application map for determining the location, type, and amount of the amendment to be applied within the zone, and
vi. use the application map to determine the location, type, and amount of the amendment to be applied within the zone.

In a further embodiment, the invention resides in a system for applying amendment to the ground of a zone, the system comprising a computer that is in operative communication with a plurality of wearable devices configured to be worn by a plurality of animals (one device per animal), the wearable device comprising a processor and a navigation module configured to determine the location information consisting of a location of an animal, and the time the animal was at the location, and determining the location information once per a first time period,
the computer being configured to:
   i. receive the location information for a geo-indexed zone from the plurality of wearable devices for a desired time period,
   ii. process the location information and create a heat map by summing the location information for the geo-indexed locations the plurality of animals are in over the desired time period, and
   iii. apply a factor index to the heat map to create a modified heat map, the factor index comprising at least one factor to multiply a set amount of amendment per geo-index location with the heat map.

In one embodiment, the system comprises a variable rate amendment applicator configured to receive the modified heat map and apply the appropriate amendment to the zone depending on the modified heat map.

In one embodiment, the variable rate amendment applicator comprises a processor and software to receive the modified heat map and control the output of the amendment dependent on the location in the zone.

In one embodiment, the first time period is between 30 seconds and 10 minutes.

In one embodiment, the location information is recorded once every first time period.

In one embodiment, the desired time period is set by the user.

In one embodiment, the desired time period is between 1 week and 3 years.

In one embodiment, the navigation module is a GPS module.

In one embodiment, the wearable device comprises a communications module to communicate said information to the computer.

In a further aspect the invention broadly relates to a system for applying amendment for a geo-indexed zone, the system comprising a computer configured to receive location information of a plurality of wearable devices each configured to be worn by an animal, the wearable device comprising a processor and a navigation module configured to determine the location information consisting of a location of the animal and a time the animal was at the location, the computer configured to:
a. receive the location information for each geo-index the plurality of animals are in over a desired time period, and
b. apply a factor index to the determined location information of each geo-indexed location to determine an amendment rate, the factor index comprising at least one factor to adjust a set amount of amendment by the location information to determine the amendment rate.

In one embodiment, the computer is configured to create an application map dependent on the amendment rate per geo-index location.

In one embodiment, the system comprises an amendment applicator configured to apply the amendment rate dependent on the respective geo-index the amendment applicator is in.

In one embodiment, the amendment applicator comprises a processor and software to receive the amendment rate and control the output of the amendment from a hopper containing the amendment dependent on the geoindex the amendment applicator is located in.

In one embodiment, the location information comprises activity information relating to time spent performing an activity in a location.

In one embodiment, the activity is at least one of urination, defecation, grazing, ruminating, standing, walking, running, resting, lying, birthing and mating.

In one embodiment, the factor index is predetermined depending on the type of amendment.

In one embodiment, the factor index is predetermined by the user, in alternative embodiments, the factor index is predetermined by the computer.

In one embodiment, the factor index is predetermined depending on the type of amendment.

In one embodiment, the factor index comprises a first factor to increase the amount of amendment to the particular location(s) of the zone depending on the heat map.

In one embodiment, the factor index comprises a second factor to increase the amount of amendment depending on the heat map where said at least one animal has spent less time compared to elsewhere within the zone, or has less activity than elsewhere within the zone.

In one embodiment, the factor index comprises a third factor to increase an amount of fertiliser depending on the heat map where said at least one animal has spent less time compared to elsewhere within the zone, or has less activity than elsewhere within the zone.

In one embodiment, the e factor index comprises a fourth factor to decrease the amount of amendment depending on the heat map.

In one embodiment, the factor index comprises a fifth factor to decrease the amount of amendment depending on the heat map where said at least one animal has spent more time compared to elsewhere within the zone, or has more activity than elsewhere within the zone.

In one embodiment, the factor index comprises a sixth factor to decrease an amount of fertilizer depending on the heat map where said at least one animal has spent more time compared to elsewhere within the zone, or has more activity than elsewhere within the zone.

In one embodiment, the factor index comprises a seventh factor to change the amount of amendment and/or select the type of amendment depending on the heat map.

In one embodiment, the factor index comprises an eighth factor to change the amount of amendment and/or select the type of amendment depending on the heat map where the at least one animal has spent more time compared to elsewhere within the zone, or has more activity than elsewhere within the zone.

In one embodiment, the factor index comprises a ninth factor to add a further amendment alongside another amendment depending on the heat map.

In one embodiment, the factor index comprises a tenth factor to add a further amendment alongside another amendment depending on the heat map where the said at least one animal has spent more time compared to elsewhere within the zone, or has more activity than elsewhere within the zone.

In one embodiment, the factor index comprises an eleventh factor to change the amount of urease inhibitor and/or select a type of urease inhibitor depending on the heat map.

In one embodiment, the factor index comprises a twelfth factor to change the amount of urease inhibitor and/or select the type of urease inhibitor depending on the heat map where the said at least one animal has spent more time compared to elsewhere within the zone, or has more urination activity than elsewhere within the zone.

In one embodiment, the factor index comprises a thirteenth factor to change the amount of fertiliser and/or select the type of fertilizer depending on the heat map.

In one embodiment, the factor index comprises a fourteenth factor to change the amount of fertiliser and/or select the type of fertilizer depending on the heat map where said at least one animal has spent less time compared to elsewhere within the zone, or has less activity than elsewhere within the zone.

In one embodiment, the factor index comprises a fifteenth factor to select an amendment to decrease negative effects of high nitrogen content caused by said at least one animal's urine and/or excrement.

In one embodiment, the computer is configured to assign the geo-indexed area the value relating to location information recorded as being within the geo-index area.

In one embodiment, the computer is configured to determine a key-value structure, where the key is the geo-index and the value is or relates to how many data points of the location information were found inside said geo-index area for the set period of time.

In one embodiment, the computer is configured to determine the location information of multiple wearable devices.

In one embodiment, the computer is configured to sum the location information for the geo-indexed locations the plurality of animals are in over the desired time period.

In one embodiment, the computer is configured to overlay, relate, or summate the location information of multiple animals, from multiple respective wearable devices to each geo-index.

In one embodiment, the system comprises the plurality of wearable devices.

In a further aspect, the invention broadly relates to a method for determining an amendment rate for a zone, the method comprising
a. providing a plurality of wearable devices each configured to be worn by an animal, the wearable device comprising a processor and a navigation module configured to determine the location information consisting of a location of the animal and a time the animal was at the location,
b. receiving location information for a desired time period, and
c. applying a factor index to the determined location information of each location to determine an amendment rate, the factor index comprising at least one factor to adjust a set amount of amendment by the location information to arrive at the amendment rate,

In one embodiment, the method comprises creating an application map dependent on the amendment rate per location, the application map configured to be read by an applicator so the applicator is able to apply amendment at the amendment rate on ground related to the application map.

In one embodiment, the method comprises applying the amendment to the zone via an amendment applicator configured to apply the amendment rate dependent on the location the amendment applicator is in.

In one embodiment, the zone is geo-indexed and the location information is indexed to the geo-index.

One or more statements above relating to one aspect may equally apply to another aspect.

Other aspects of the invention may become apparent from the following description which is given by way of example only and with reference to the accompanying drawings.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, a reference to such external documents is not to be construed as an admission that such documents, or such sources of information, in any jurisdiction, are prior art, or form part of the common general knowledge in the art.

It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for inclusion of not only the listed components or elements, but also other non-specified components or elements. The terms ‘comprises’ or ‘comprised’ or ‘comprising’ have a similar meaning when used in relation to the system or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in the claims and unless stated otherwise, the word ‘for’ is to be interpreted to mean only ‘suitable for’, and not for example, specifically ‘adapted’ or ‘configured’ for the purpose that is stated.

For the purpose of this specification, where method steps are described in sequence, the sequence does not necessarily mean that the steps are to be chronologically ordered in that sequence, unless there is no other logical manner of interpreting the sequence.

The entire disclosures of all applications, patents and publications, cited above and below, if any, are hereby incorporated by reference.

### BRIEF DESCRIPTION OF THE DRAWINGS

Preferred embodiments of the invention will be described by way of example only and with reference to the drawings, in which:

FIG. 1: is a flowchart showing a graphical interpretation of information according to a first embodiment of the present invention.

FIG. 2: shows one example of a general communication system infrastructure diagram incorporating the features of the invention in an example where a position and/or activity of an animal in a field is being recorded according to the present invention.

FIG. 3: shows a wearable device on an animal to be used in the system of the present invention.

FIG. 4: shows a snapshot of location information of a herd on animals in a paddock/zone at a single point of time.

FIG. 5: shows a modified heat map of location information of a herd of animals over a period of time with the paddock/zone of FIG. 4.

FIG. 6: shows an application map derived from the modified heat map of FIG. 5.

FIG. 7: shows a heat map of cow location information over a period of time within a paddock.

FIG. 8: shows activity data correlations with movement of a wearable device.

FIG. 9: shows how pitch and overlay dynamic body acceleration relate to each activity.

FIG. 10: shows a table of factors that might be contained in the factor index.

FIG. 11: is a block diagram showing one example of how a device might source the heat map and factor index data to produce the modified heat map.

FIG. 12: is a schematic of the process of creating a heat map from the wearable device data using a cloud computing service.

FIG. 13: shows a hexagonal heat map created for a zone map, shown on a mobile device screen.

### DETAILED DESCRIPTION

With reference to the above drawings, in which similar features are generally indicated by similar numerals, a system according to one preferred embodiment of the invention is generally indicated by the numeral 18.

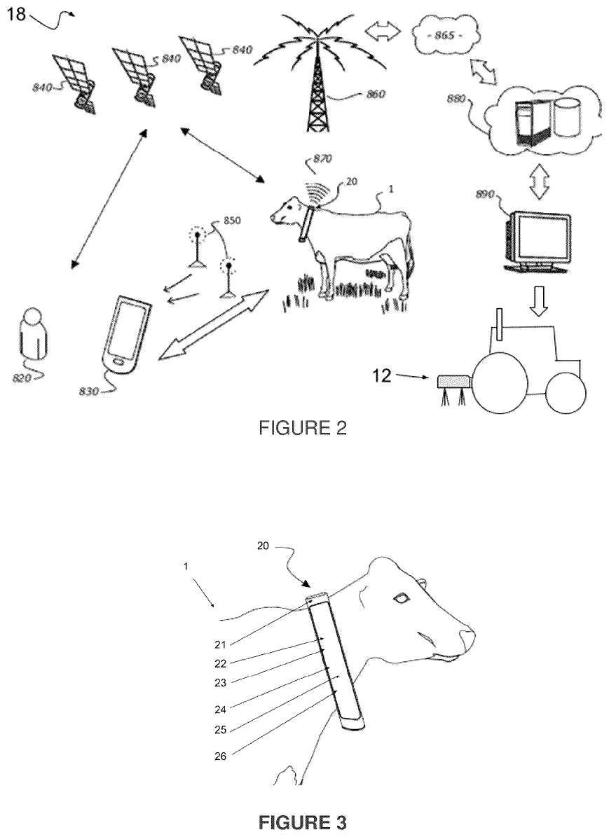

In general, the system and method of the present invention comprises a wearable device 20 that is configured to be worn by a grazing animal 1 (which in this preferred embodiment is a bovine). The wearable device 20 may be in the form of an animal collar that is configured to be worn around the neck of the animal 1 as shown in FIGS. 2 and 3. The wearable device 20 is configured to determine at least one of the location 1b of an animal and movement 1a of the animal 1 or part of the animal, as well as store and/or communicate information (data) pertaining to the location 1b and/or movement 1a to one or more devices that is external to the wearable device 2. For example, the wearable device 20 may comprise a navigation module (e.g. GPS module) to obtain the location and/or a positional information. The location and positional information may be modified by a series of steps to obtain processed information, and the processed information may then be uploaded or communicated to the external device(s), which in this example is an applicator 12. The applicator 12 may be configured to selectively and/or variably apply an amendment 13 to zone 4 containing pasture, crop, or similar based on the processed information received from the wearable device. Where applying the amendment 13 to the zone 4, does not necessarily mean applying the amendment 13 to the entirety of the area of the zone 4, but instead means applying the amendment 13 to one or more locations or areas within the zone 4. This can also be described as applying the amendment 13 to particular locations within the zone 4.

The amendment may be an amendment to enhance pasture, soil, or crop growth (herein pasture, soil and crop terms are to be used interchangeably); reduce, kill, or inhibit growth of non-desirable plants or pests; convert, inhibit, or otherwise affect the pasture, crop, and/or other compounds or structure present. For example, a fertilizer may be applied to increase grass growth, a urease inhibitor may be applied to reduce the conversion of surface applied urea to ammonium etc.

Optimizing the quantity/amount and type of amendment to a zone is important to increase productivity of the pasture and reduce fertilizer inputs that would have otherwise been added to the pasture. Reducing inputs may lower costs and may lower environmental risk.

Reducing the use of nitrogen fertiliser may reduce nitrogen leaching. Further, high nitrogen fertiliser use on pastures may lead to a high concentration of nitrogen in the diet of grazing animals, resulting in increased nitrogen in urine, which influences nitrous oxide emissions and nitrogen leaching losses. On the other hand, pasture needs nitrogen to grow and non-optimal nitrogen supply will affect plant productivity, resulting in reduced pasture yields. Reduced pasture production means more off-farm inputs will be required and profitability could go down while the net reduction in emissions may be negligible. As such, the correct amount of fertilizer to be applied is important.

The applicator 12, in one embodiment, is an amendment applicator that is configured to receive the processed information as an application map 7, or an amendment application rate, and apply the appropriate amendment type and amount to the pasture 3 dependent on the application map 7 or amendment application rate. In one embodiment, the applicator 12 is a fertilizer truck or tractor towing a spreader or sprayer. Preferably the applicator 12 comprises an appropriate computer system capable of receiving the application map 7, processing the application map 7 appropriately, and controlling mechanical aspects of the applicator 12. The applicator 12 may be a known applicator such as a ‘variable rate spreader’ which is known in the art. From here on, the application 12 when mentioned will also include the applicator computer system. A person skilled in the art will know what is required for the applicator 12 to receive and process the application map 7, and actuate the mechanical aspects accordingly. Preferably the applicator 12 can receive the application map 7 and apply the correct amendment accurately and automatically whilst the applicator 12 is driven or controlled about a zone 4 that contains the pasture 3. The mechanical aspects may be, or may include, the vehicle itself, a propelling mechanism to propel the applicator about a paddock, the mechanisms that physically apply the amendment, such as sprayers, nozzles, gates, or spreaders etc. In one example the applicator 12 is an autonomous vehicle, such as a drone, and may incorporate one or more of the mechanical aspects such as sprayers, nozzles, gates, or spreaders etc. The applicator 12 preferably comprises a position sensing system configured to determine which geo-index the application 12 is located within, such that it can apply the correct amendment to the related geo-index. Such a position sensing system may be a GPS or like navigation means. In other embodiments, the user can view the application map or amendment application rate and can manually adjust the output of the applicator accordingly.

The steps for creating the application map 7 from the information 10 will now be described.

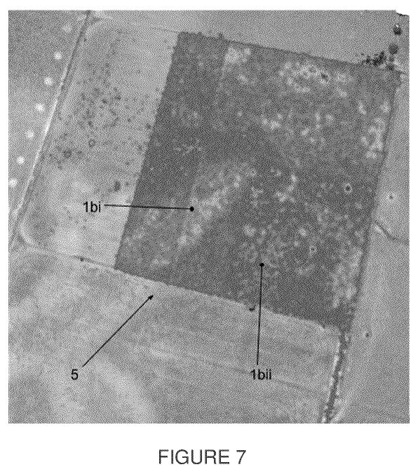

The movement information 10a and/or movement information 10b (both known as information 10) is processed to create a heat map 5 of where the animal is most often located, and/or performs particular actions, over a period of time. As a skilled person will appreciate, in the context of the present invention the heat map 5 has nothing to do with heat but is so called because of the appearance it takes when displayed graphically. The heat map may however include activity that relates to the animal being on heat (estrus). An example of a heat map is shown in FIG. 7. FIG. 7 shows cumulative location data of a plurality (in this example a herd) of animals 1 constrained within a paddock/zone over time. In FIG. 7, areas of high cumulative location time 1bi are shown with lighter shade/colour, and areas of low cumulative location time 1bii are shown in darker shade/colour. The heat map may also not be displayed graphically, and may instead merely be a descriptor of the data which comprises the movement information.

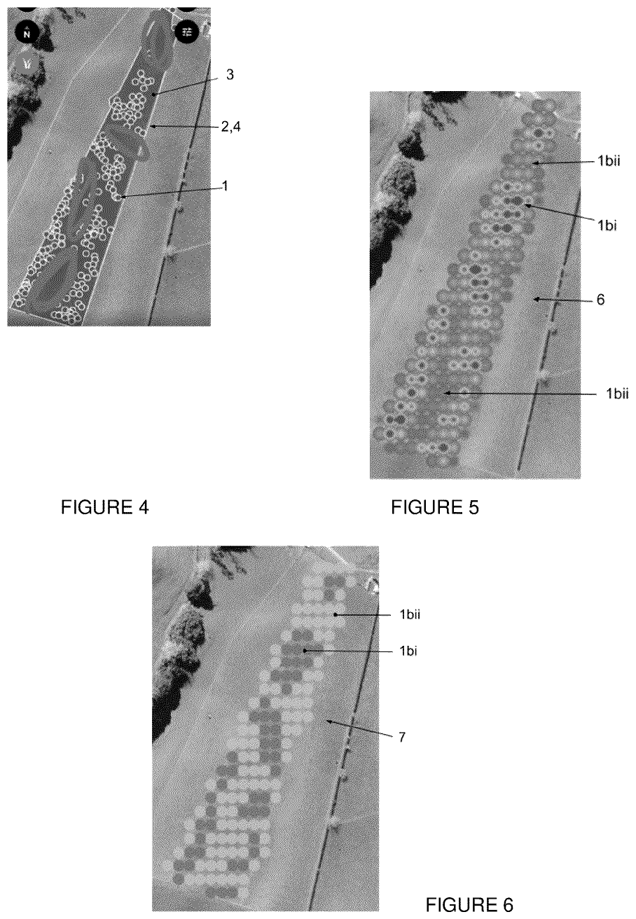

Animals tend to spend more time on flatter areas, instead of slopes; under trees when sunny; or in a specific location(s) for various reason(s). These locations can change over a period of time. The period of time is usually a set period of time that the animals are in the paddock or zone 2,4. Alternatively, the period of time may be over one or a number or hours, days, weeks, fortnights, months, years, time between amendment applications, or any other period. FIG. 4 shows an image of location data of animals 1 at an instant in time. In FIG. 4, the overlaid circles show where animals are not present, these areas are mainly sloped areas. The location of animals at an instant in time does not always line up with the heat map, as the animals move during the time period. For example, the uppermost circle in FIG. 4 shows no animals at that instant in time, however the cumulative time spent in that same area is high as shown in a modified heat map (described further below) of FIG. 5.

The heat map 5 is typically created from information (e.g. location or positional information) from animals in a paddock 3 (or field, fenced area). The heat map 5 may be created on a computer 890, device 830, wearable device 20, and/or cloud server 880 as described later.

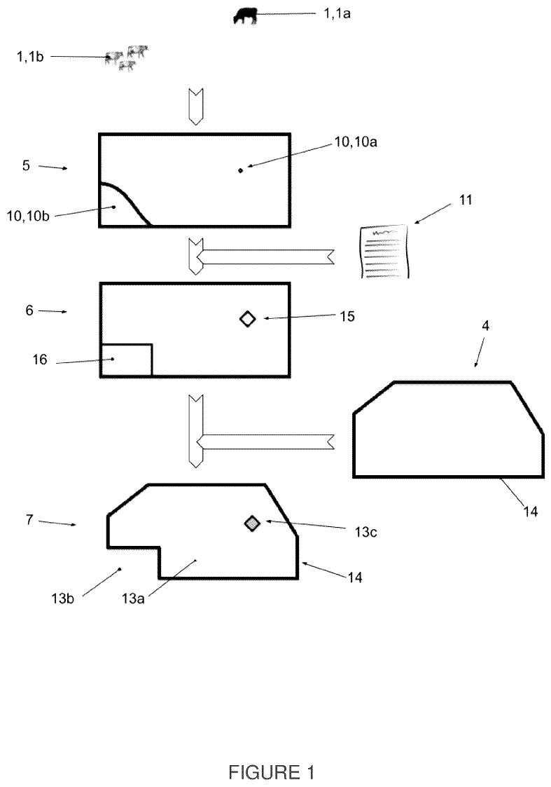

The paddock may be physically or virtually fenced, or have no fences at all. The zone or zone map 4 (herein zone and zone map are used interchangeably) is the area which amendment is to be applied to. The zone map 4 is shown in FIG. 1. The zone 4 may be co-spatial with the paddock 3, or it may be different. For example, the farmer may only want half of the paddock 3 to have an amendment applied to it, in which case the zone 4 will be half the paddock 3. The zone map 4 is typical in the state of the art for uploading to an amendment applicator.

In the example given below, the heat map 5 for a particular zone map 4 is created. As such the heat map 5 only contains data for the required zone map 4. Subsequently the heat map 5 may be altered via a factor index 11 to create an application map 7. The application map can then be read by the applicator 12 to then be able to apply the correct amendment/fertiliser to the zone.

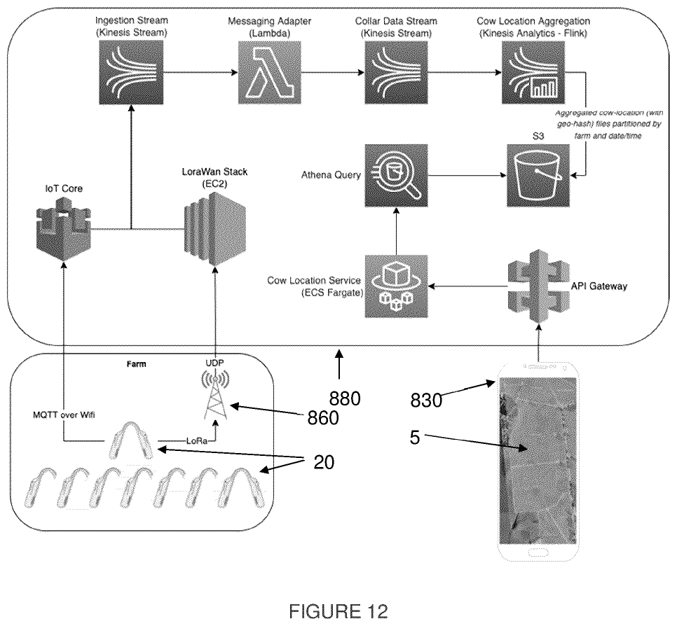

FIG. 12 gives an overview of a system schematic that may be used to create the heat map 5. This system in particular utilises cloud computation. In particular, this system may be run through Amazon Web Services, but a skilled person in the art will realise that other cloud computing or local computing options are also possible.

Data Sent from the Wearable Device

For heat map 5 to be created, the information (location data, movement data, collar ID, and/or time data etc) needs to be received from the wearable device (e.g. collars) 20. This information is from where the collars 20 may be located, such as a farm or other like location, to a ‘backend’ cloud computing service 880. The backend is configured to analyse the information (also herein called data) and aggregate the data and assign it to a geo-index. This indexed data can then be retrieved via a mobile device 830 or similar as requested by a user. Preferably the information is received by the backend 880 for multiple wearable devices as shown in FIG. 12.

In some embodiments, the information is aggregated to save the power of the collar or for reasons, such as saving data or communication bandwidth. In one embodiment, the information is aggregated, or collected only once, over 3 minute periods (‘aggregation time periods’). However other aggregation time periods (and/or averaging of the data) may be possible. Such as 30-second averages up to 1-hour averages. Each aggregation, either separately or in combination, is then sent off the wearable device, instead of every data point. In one embodiment, the location of the animal is taken once every aggregation time period, and that one location is the sole data point for the time period.

The data is sent via a communications module. One which is capable of LoRaWan, WiFI or another communication standard, as schematically shown in FIG. 12. The data may be sent as MQTT over WiFi, or another equivalent protocol. FIG. 12 has a label for the ‘Farm’ to distinguish the locations of these functions at the backend.

### BackEnd

In the embodiment shown in FIG. 12, the data is sent to the cloud 880, or other equivalent or similar off-site server, processor or computer. In one embodiment, Amazon Web Services is utilized as the ‘backend’ cloud computing service 880. The backend 880 is configured to receive the information and prepare it to be requested as a heat map 5, or as information to create a heat map 5, by the device 830 or the like. The following steps are used in one embodiment to prepare the information received from the wearable device 20 so it can be retrieved quickly and easily by device 830. Not all of the following steps are essential, but the addition of all of these steps make the process more efficient to retrieve and analyse the information.

Ingestion stream: In one embodiment, information coming from either or both the WiFi and LoRa is sent and aggregated via an ingestion stream. In one embodiment, AWS Kinesis Stream (or another equivalent service) is used to aggregate the data from one or both of said sources.

Messaging Adaptor: A messaging adapter is configured to receive the ingestion stream. The primary purpose of the messaging adapter is to clean the information. The messaging adapter is configured to one or more of deduplicate, decode and split the information. This service may be run on AWS Lambda or other equivalent services or programs. The information is then sent into a collar information stream.

In one embodiment, the messaging adaptor receives the information as a protobuf payload from the ingestion stream. Protocol Buffers is an efficient encoding technique, which compacts the information into a binary format and can be decoded in a different language. The messaging adapter may further transform this binary information from the ingestion stream into a more human-readable format. In one embodiment, JavaScript Object Notation (JSON) is used as the format.

Collar Data Stream: A Collar data stream is configured to temporarily store and process the information. There may be multiple consumers of a stream to process the information for various purposes. One of the consumers of this stream of information is a Cow Location Aggregator. The collar data stream may be hosted on an AWS Kinesis stream or equivalent service.

Cow Location Aggregation: The collar data stream then needs to be analysed and indexed via its labelled location. At this stage, the location information from the collars 20 is aggregated and assigned a value relating to time spent at a geo-indexed area (aka location, or hexagon) over a specified time period.

In one embodiment, the value is the total number of data points that have been identified as inside the geo-index over the specified time period. As the data points are aggregated over 3 minute periods from the collar, then each 3-minute data point will correspond to one data point at a location. As such, the value of a geo-indexed location (hexagon) will be how many data points are recorded in an aggregated period of, say, a time period of 10 minutes. So if one animal is within a geo-indexed location for 10 minutes, the geo-indexed location will have a value of four. If there are two animals within a geo-indexed location for 10 minutes, the geo-indexed location will have a value of eight. As described previously, the data periods, i.e. the check-in times for the collar may be larger or smaller than 3 minutes. For example, if the collar sent data every 1 minute, a stationary animal may have a value of 10 for a geo-index over a 10 minute period.

In one embodiment, the time period used is 10 minutes, however, other time periods are possible depending on the amount of information and/or resources available. For example, over the course of a 10 minute period, the Cow Location Aggregation will determine how many animals (location data points with a specified location) have been in one geo-indexed location and given an associated value. This is performed for each geo-indexed location in zone map 4. In one embodiment, AWS Kinesis Analytics-Flink is used for analysing the information, but equivalent programs may be used.

Should an animal spend longer in a location, this may also be recorded. However in a more simplified embodiment, if an animal merely spends time at two locations within a geo-indexed location, then only two locations would be recorded and go towards the cumulative total.

In one embodiment, the geo-index used is the hexagonal H3 grid database and the associated values of location information are assigned to the respective hexagonal grid location the data point is located in. The H3 grid is a geospatial indexing system that is hexagonal and can be subdivided into smaller grids. It is a multi-precision tiling of the entire world with hierarchical linear indexes to organize data. In one embodiment, resolution 13 is used to determine the size of the hexagon for zone map 4. A higher or lower level of granularity may be achieved with different resolutions. A person skilled in the art will be able to determine what resolution is required depending on the granularity the applicator 12 can apply the fertiliser/amendment as well as other variables such as processing power, time, and want of useful information. Further information on the H3 grid can be found on https://h3geo.org/.

The hexagonal grid index that the data points are indexed to will relate directly to like hexagonal grids on zone map 4. I.e the hexagonal grid is standardised for all locations on a globe.

Dumps: The aggregated data from the cow location aggregation, each with respective indexed hexagonal grids are stored at a ‘dump’ or container. In one embodiment, the data is stored with Amazon Simple Storage Service (S3). S3 is a storage service on AWS where files can be securely stored and with a high durability guarantee. This is where the aggregated information (locations on a farm per 10 min time period) files are stored.

In other words, the information of cow location (and/or movement etc) is aggregated into 10 minute periods and indexed to a particular geo-index (e.g a hexagon).

### Requesting and Pulling Data

API Gateway: The user requests are handled by a backend API Gateway. An API gateway is an API management tool that sits between a client/user and a collection of backend services, in this embodiment the cloud service. An API gateway acts as a reverse proxy to accept all application programming interface (API) calls, aggregate the various services required to fulfil them and return the appropriate result. In this particular example, the API gateway receives any commands from the user via device 830. The API will trigger a query from the user commands. In this embodiment, the query is an Athena Query from AWS. The application (on the mobile phone for example) then receives a token and the application can request the status of the query execution. Once the execution is done, the backend will transform the result into a key-value structure, where the key is the geo-index and the value is how many cow locations (data points) were found inside that geo-index for the query period.

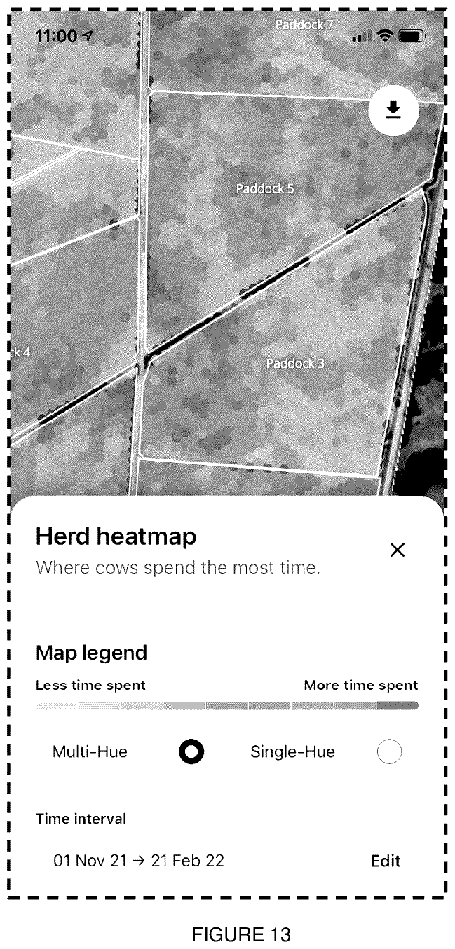

Cow Location Service: A system is used to orchestrate the querying mechanism and process the query result into a digestible format that the mobile app 830 can interpret and subsequently render the heat map 5 as shown in FIG. 13.

In this instance, ‘Cow Location Service’ is a backend system that orchestrates the querying mechanism, Athena, on AWS.

Athena Query: A zone map 4 can include boundaries that the geo-indexing can be used within to make up zone map 4. I.e zone map 4 will be made up of a geo-indexed map, with a number of hexagons (in this one embodiment) that relate to the area of the zone map.

In another embodiment, zone map 4 doesn't include boundaries but is a selected number of wearable devices that may make up a herd or number of animals that are known to be at a zone or farm. As such the Athena Query requests solely the wearable devices that are known to be located at the desired zone, and within the desired time period.

In one embodiment, if the centre point of a hexagon is found within the desired zone map 4, the hexagon is considered to be within zone map 4. Increased resolution of the hexagons can reduce the area of hexagons found outside zone map 4, but at other costs.

The user can query the location values for a given time period (‘a set period of time’) of the zone map's hexagons. For example, the user will ask, via sending a query or command, to pull information from the S3 container. The query may be made via a GUI which then queries via an Athena Query or similar. The query will include the bounds of the geo-indexing required.

The query will also include information on the time period required. For example, should the user want a heat map 5 of a zone map 4 with information for 1 year of animal location data, then the user will input a 1 year time period and select the particular zone map. The query will then have the time bounds to then pull the relevant information from the dumps relating to information from that time period, and for that zone map.

Visualised on Device: A key-value structure is then ‘overlaid’ or compared to zone map 4 to create the heat map 5. Where the mobile device processes the zone map 4, and indexes the hexagons within the zone map 4. The mobile device then matches or pairs each zone map geo-index with the key-value structure from the API Gateway.

The information is pulled and aggregated for each geo-index over the desired time period. Once all the required hexagons are pulled and aggregated for zone map 4, the area of the hexagons can then be scaled with a value or colour dependent on the range of values. In one embodiment, the scale may be a colour scale so that the zone map with the hexagons can be easily visualised.

Further or alternatively, the map may be sent to other software for applicator 12, or directly to applicator 12 so the application of the amendment can be amended accordingly. In this embodiment, the hexagons will not necessarily have a colour scale, or have any graphical representation, applied as the heat map 4 will not be viewed by a human. Instead, the heat map may merely be a table or data dump with the required information of the aggravated location data per hexagon over a time period that is able to be read by further software or by the applicator 12.

The heat map 5 may be further modified with factors 11, to make a modified heat map 6. Modification of heat map 5 to create the modified heat map 6 is discussed later. Optionally, the modified heat map 6 is then modified with the zone map to form the application map, should the heat map not already be the same as the zone map area/location.

Alternatively, a heat map 5 is made for an area, and then modified to make the modified heat map 6, and then zone map 4 is applied (instead of being utilised earlier to make the heat map). A person skilled in the art will realise there are many processes, and different orders to make the heat map, modified heat map, and application map.

The zone map 4 defines the area and a boundary 14 for which to apply amendment 13 to, typically the zone map 4 will also comprise information about a desired application rate of the amendment 13. For example, the desired application rate may be mass of fertilizer per unit area, or may be a volume of inhibitor per urine patch.

Existing companies such as TracMap™ may be able to, or may be modified to, control the application rate of amendment 13 via control of the applicator 12. The applicator may be a variable rate spreader which is known in the art. Currently, TracMap™ may only be capable of affecting the application of one amendment, but it is a good example of current systems.

There will be a certain limit of “granularity” of the application of the amendment due to the preciseness and controllability of the applicator 12. In other words, there is a certain physical dimension or level of detail to which an applicator can apply the amendment material. The amendment types will typically be provided as flowable, pourable or sprayable substances, whether provided in fluid or solid states. For example, if the applicator 12 is being used to spray a sprayable amendment using a 12 metre boom, and the individual spray nozzles along the boom are not individually controllable, then the minimum width of application will be 12 metres. Ideally, the applicator 12 will have smaller granularity than 12 metres, for example, a 1 m long or 1 m² granularity, or even less area when targeting urine patches.

Preferably the applicator 12 and/or applicable software is able to recognise the geo-indexing standard used. Alternatively, the applicator 12 can reprocess the heat map to its own standard.

The heat map 5 may be modified by a factor index 11 to create a modified heat map 6. The factor index 11 comprises a list, index, or matrix of factors, that optionally along with the zone map 4, are used to modify the heat map 5 to create a modified heat map 6. The modified heat map 6 preferably also comprises factors that are configured to modify desired application rates when combined with the zone map 4. The factor index 11 may be incorporated in the software application or stored as information in persistent memory of a computer 890, device 830, wearable device 20, and/or cloud server 880 that applies an algorithm to create the modified heat map 6. The factor index 11 at least comprises factors that are used to weight the activity information in the heat map 5 and combine it into factors of the modified heat map 6. For example, an animal that is resting or stationary may have more weighting on the heat map compared to an animal that is moving. Similarly, an animal that is urinating or defecating will have more weighting on the heat map compared to an animal that is moving. Activity information of different animals may be combined for example by means of a weighted average or sum dictated by the factors.

The factors of the modified heat map 6 are configured to modify input variables of desired application rates and/or amendment types, as opposed to the factors of the factor index 6 which are configured to weight and combine input of activity information from the heat map 5. The factors of the modified heat map 6 are at least partially derived from output of the factor index 11 modifying the heat map 5.

The factors of factor index 11 and/or the modified heat map 6 may be configured to modify inputs using one or more mathematical relationships, for example linear, polynomial or exponential relationships. Factors of the factor index 11 and/or the modified heat map 6 may therefore include coefficients of such mathematical relationships. Alternatively, other suitable algorithms may be used, and the factors may for example include tuning parameters of such algorithms.

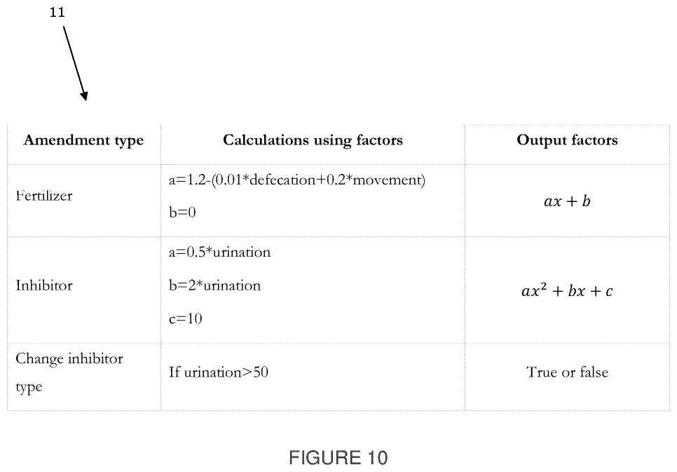

FIG. 10 shows how the factor index 11 might use factors including linear relationships to combine input activity information and calculate factors for heat map 6 in the form of coefficients of mathematical relationships. In this example, defecation, movement and urination values may have been previously determined by a weighted average or sum between animals.

As would be appreciated by a person skilled in the art, in FIG. 10:
ax+b is a linear relationship, and
ax²+bx+c is a polynomial relationship.

For example, the desired application rate is 100 kg/hectare which is 10 kg/10000 m². If the applicator 12 has 1 m² granularity, it can apply the amendment differently to each square metre. In 1 m² the desired application rate will be 100 g/1 m², which may for example be a value stored in the zone map 4 or within the factors 11. However, should the heat map 5 determine that one animal has camped out, e.g. remained substantially confined, in a 1 m² area for 1 hour, there will likely be excess fertilizers in that area of 1 m², and thus the application rate can be lowered in that area of 1 m², yet the overall fertilizer in the area of 1 m² will still be at the desired level that would have been achieved through the desired application rate. Thus, for example, the actual applied or amended application rate should be modified to a lower amount such as 50 g/m² where animals have camped for a period of time.

Alternatively, should heat map 5 show that there has been four recorded data points within a geo-indexed location over a period of time, of say 10 minutes, then the amendment may be scaled according to said value of four.

The factor index 11 comprises the factors which weight the locations and/or activity information of heat map 5 to produce a modified heat map 6 of factors configured to amend the desired application rate to arrive at the actual applied or amended application rate. In this example, for a 1 hour camp period of 1 animal, the factor index 11 might weigh this activity information in combination with other activity information to arrive at a multiplicative factor for fertilizer of 0.5 (equivalent to a simple linear relationship) stored in modified heat map 6. Applying the factor of the modified heat map 6 to the desired application rate, for example during the application of zone map 4, this will shift the desired fertilizer rate of 100 g/m 2 to 50 g/m² which will be reflected in the final application map 7. It is to be noted that the measurements provided herein are purely an example only.

The factors are also capable of changing the amendment type, and/or adding or subtracting an amendment type. For example, as shown in FIG. 1, if the heat map 5 contains activity information 10 of an animal urination area 10a, then the factor index 11 can create the modified heat map 5 with information, for example, to affect an inhibitor 13c to be sprayed onto the animal urination area 10a. The fertilizer rate may stay the same over this area, or it may also change in quantity or type. The application rate, amendment type etc will depend on the farmer's desired inputs, or application system they want to use. This detail will be included into the factor index 11. For example, some farmers may not wish to use an inhibitor 13c on urine patches, but other farmers might. As such, the farmer/user can input this requirement to the factor index 11 to therefore affect the application map 7.

Changing the type of the amendment may be as simple as having multiple amendments on board an applicator, e.g. two different spray fluids/amendments. One spray fluid may be a urease inhibitor (for example) and the other spray fluid may be fertiliser (for example). The application should have the capability to turn off and on each amendment type depending on the application map 7 requirement. The applicator may have two, three, four or more amendments available, on board the applicator, to apply to a paddock. The application may have the capability to apply two or more of the amendments simultaneously.

Each amendment may be of the same or different mediums. The amendments mediums for example may be fluid, gels, granules, powders, or seeds etc.

Each amendment type may have different granularity, i.e. the area it can be applied to, due to its medium and application mechanism. For example a granular medium applied by a spreading mechanism may have less accuracy and granularity than a fluid medium applied via a spot sprayer. The details of the granularity may be known and taken into account.

The factor index 11 will include many factors depending on one or more variables; the variables comprising:
a. number of animals (collars) at a location.
b. the number of data points, or gps points recorded from the collar as being at a location.
c. time spent by an animal at a location,
d. type of activity of an animal at a time, and
e. cumulative time spent by an animal doing an activity.

Either the factor index 11 or the zone map 4 comprise the desired application rate and type (also known as input variables). It does not matter at what stage these input variables are included into the calculation. For ease of explanation, the input variables are included with the zone map 4, where a zone map is created that determines where the amendment is to be applied, and how much is to be applied. If the input variables are included in the zone map, then the desired application rate is set out in the zone map 4. If the input variables are included in the factor index 11, then the heat map 5 is modified with both the desired rate and a factor.

The factor index 11 also takes into account the granularity and specifications of the applicator so that a granularity created in the modified heat map 6 is able to be turned into useful information for the application map 7 which can actually be read and output reliably by the applicator 12. For example, the modified heat map 6 will not change amendment output every 0.5 m² if the applicator 12 can only physically change the amendment output every 1 m². This granularity may also be taken into account by including it in the zone map 4 instead of the factor index 11.

Once the factor index 11 has been applied to the heat map 5 to create a modified heat map 6 with amended rates and types, then the zone map 4 is overlaid to define the boundaries of the application map 7 as shown in FIG. 1. This step may be optional, if the heat map 6 is already defined by, or is the same as, the zone map 4. The application map 7 is used to control the type and amount, if any, of the amendment 13 to be applied to zone 4. The application map 7 is used to control the applicator 12 to therefore output the amendment amount and type as determined by the application map 7. The application map 7 may be loaded into the computer system of the applicator 12. In other embodiments, the application map 7 also comprises the correct granularity of amendment to be consistent with the applicator 12. The application map 7 may also define the boundaries of the area that is the area to be amended.

Some example factors that one or more may be used to create the modified heat map, or application map.
1. A first factor to increase the amount of amendment to the particular location(s) of the zone depending on the heat map.
2. A second factor to increase the amount of amendment depending on the heat map where said at least one animal has spent less time compared to elsewhere within the zone, or has less activity than elsewhere within the zone.
3. A third factor to increase an amount of fertiliser depending on the heat map where said at least one animal has spent less time compared to elsewhere within the zone, or has less activity than elsewhere within the zone.
4. A fourth factor to decrease the amount of amendment depending on the heat map.
5. A fifth factor to decrease the amount of amendment depending on the heat map where said at least one animal has spent more time compared to elsewhere within the zone, or has more activity than elsewhere within the zone.
6. A sixth factor to decrease an amount of fertilizer depending on the heat map where said at least one animal has spent more time compared to elsewhere within the zone, or has more activity than elsewhere within the zone.
7. A seventh factor to change the amount of amendment and/or select the type of amendment depending on the heat map.
8. An eighth factor to change the amount of amendment and/or select the type of amendment depending on the heat map where the at least one animal has spent more time compared to elsewhere within the zone, or has more activity than elsewhere within the zone.
9. A ninth factor to add a further amendment alongside another amendment depending on the heat map.
10. A tenth factor to add a further amendment alongside another amendment depending on the heat map where the said at least one animal has spent more time compared to elsewhere within the zone, or has more activity than elsewhere within the zone.
11. An eleventh factor to change the amount of urease inhibitor and/or select a type of urease inhibitor depending on the heat map.
12. A twelfth factor to change the amount of urease inhibitor and/or select the type of urease inhibitor depending on the heat map where the said at least one animal has spent more time compared to elsewhere within the zone, or has more urination activity than elsewhere within the zone.
13. A thirteenth factor to change the amount of fertiliser and/or select the type of fertilizer depending on the heat map.
14. A fourteenth factor to change the amount of fertiliser and/or select the type of fertilizer depending on the heat map where said at least one animal has spent less time compared to elsewhere within the zone, or has less activity than elsewhere within the zone.
15. A fifteenth factor to select an amendment to decrease negative effects of high nitrogen content caused by said at least one animal's urine and/or excrement.

The above description relates to specific embodiments of the invention, however in a broader aspect the invention may not comprise one or more of the zone map, heat map, modified heat map, and application map. In such embodiment, the computer is configured to receive the location information from the wearable devices and determine the location information per geo-index, or per location. A skilled person in the art may not require using a geo-indexing method. The location information can then be directly applied to the factor index, to arrive at an amendment rate for each location or geo-index. The amendment applicator is configured to retrieve the amendment rate for the geo-index it is in, and apply the amendment accordingly. E.g. the terms herein describing maps etc are used to more easily describe the invention, but the invention may be without such.

For example, a method for determining an amendment rate for a zone, the method may comprise the following steps. Providing a plurality of wearable devices each configured to be worn by an animal, the wearable device comprising a processor and a navigation module configured to determine the location information consisting of a location of the animal and a time the animal was at the location, The method further comprises receiving the location information for a desired time period. The desired time period may be selected by a user. The method further comprises applying a factor index to the determined location information of each location to determine an amendment rate, the factor index comprising at least one factor to adjust a set amount of amendment by the location information to arrive at the amendment rate, Said steps of receiving and applying a factor index to determine the amendment rate may be carried out by a processor or computer. Such calculations of many animals, location data, behaviour data (where applicable), per location is too difficult to be undertaken without a computer.

Most of the above is achievable with accurate location and/or activity information of the animal 1 or animals 1, over a period of time. To achieve this, the animal 1, or one or more animals in a herd 1 of animals, wears a wearable device 20 to collect said information of location and/or activity. The wearable device 20 comprises a number of features that allows it to collect, store and communicate the information. Such features are similar to most wearable devices that are used for fitness in the market currently, but adapted for animals. In particular, the wearable device 20 is sufficiently rugged/strong to withstand potential rough handling by the animals. Furthermore, the wearable device 20 has accurate determination of the movement of the animal 1 so that the activity of the animal can be determined. To achieve this, the wearable device 20 should be worn in a consistent fashion on the animal 1, and also have accurate measuring tools.

The wearable device 20 comprises one or both of 1) a navigation module e.g. a GPS module to aid in determining location information relating to cumulative time an animal has spent in a location, and 2) at least one position sensor (position sensing device) selected from one or more of an accelerometer, inertial measuring unit, and magnetometer. The one or more of an accelerometer, inertial measuring unit, GPS, and magnetometer (collectively known as movement devices) is/are configured to aid in determining activity information relating to the activity of the animal via determining movement of the animal and/or part of the animal. The activity/activity information is related to one or more activities of urination, defection, grazing, not grazing, standing, resting, lying, birthing, mating, on heat, and/or other activity. These activities are determined by determining the movement of the animal, and learning what movement patterns relate to what activities. Various machine learning algorithms/machine learning techniques that are currently known in the art may be used for learning what movement patterns relate to what activities.

The wearable device may be of the wearable device, or collar, as described in WO2019180623A1.

For example, the wearable device 20 may be a collar that is worn around the animal's 1 neck. The collar may be fitted around the neck of the animal 1 attached so that it stays upright in a consistent position. The wearable device 20 may also be any other suitable device that is configured to be worn on other body parts of the animal, such as but not limited to leg, tail, torso or suitable body part of the animal 1.

The wearable device 20 comprises a processor to control the movement (navigation and/or position sensing) devices and receive the activity information from the movement devices. Further, the processor can utilise a communications module, comprising sais GPS module etc.

To create the heat map requires detection of movement such as angular position and/or 25 location of the animal 1. This is done using the movement devices comprising an angular position sensor such as IMU, gyroscope, or location sensing device such as navigation sensors GPS or LPS. More preferably, solely the GPS location information is used to determine the location of the animal 1. The location information of the animal 1 is recorded at a frequency over a period of time. The location and/or position information is then stored or communicated to the computer 890, device 830 and/or cloud server 880. The location information (including the activity information if taken) may be communicated from the wearable device 20 (in this example, a collar) using a communications module, capable of one or more of Internet (e.g. using WiFi) 865, Bluetooth, Infrared, cellular transmissions such as 3G, 4G, LTE etc. A software application may be used to access the information (movement and/or location information) stored on a remote server, such as cloud server 880. The information contained in the cloud server 880 can also be accessed by remote processor of a computing device, such as a PC 890 or a mobile device 830, via a connection through the Internet 865. The PC 890 or a mobile device 830 can turn the location information over time and/or movement information into a heat map.

In a more specific example, a user 820 may use a software application (such as mobile app) on a user device such as a mobile device 830, which includes, or can receive the information from receivers capable of detecting signals originating from GPS satellites 840, WiFi repeater/booster stations 850, and one or more cell towers 860, as well as 20 signal 870 originating from a collar 20 carried by the cow 1. The device 830 can then create the heat map using the received communicated information from the collar 20.

The factor index 11 may also be accessible and modifiable by a user 820 through a software application or remote processor of a computing device. This may allow farmers to adjust the desired weighting of activity information through modification of factors, and/or to customise the amendments 13 that are associated with each activity. Modifications to the factor index 11 may be propagated to a computer 890, device 830 or wearable device 20 using any of the remote communication means as described above. Alternatively, modifications to the factor index 11 may be communicated to the device 830,890 via a direct wired connection, for example using a serial bus.

The above features are used to enable a system 18 to achieve the desired function of the invention.

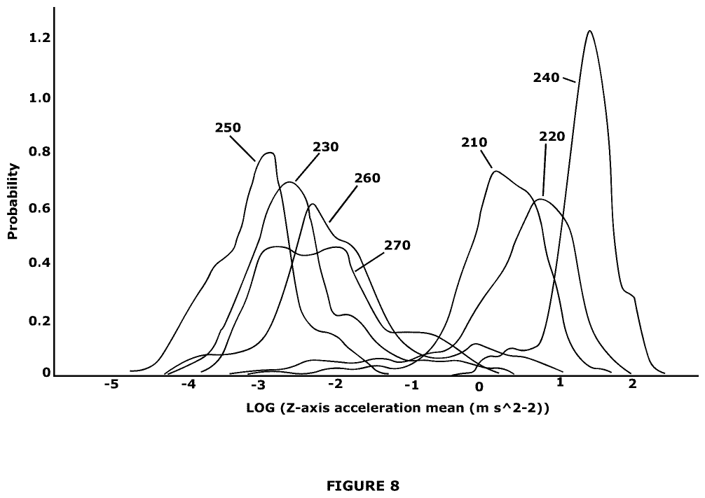

Detection of angular position of animal 1 can provide an indication of movement in an up and down direction as well as in a left or right direction. If the movement device (an angular position sensor) senses the head movement of an animal 1 such as a cow in a field, then movement in an up and down direction can indicate that the animal is eating food from a location lower than its normal standing and resting condition. The head and neck of the animal 1 will be moving up and down relatively more frequently than if the animal 1 was merely loafing (resting). Similarly, movement in a left and right direction which indicates that the animal is turning/heading to either a left or a right direction. Other activity types may also be determined by the processor (or later in by the PC or mobile device) on the basis of measured/sensed position value(s) (angular position and/or location value) and comparing such measured/sensed position value(s) with a predetermined value(s) relating to the position(s). If the measured position value is within or the same or is substantially the same as the predetermined value(s), it may be determined that the position value(s) of the animal 1 is normal and the animal 1 is grazing. However, if the measured/sensed position value(s) fall below or substantially below or exceeds or substantially exceeds the threshold pre-determined value(s), it may be determined that the angular position is different, and the animal 1 is either undertaking another activity such as lying, running, sleeping standing or urinating. Each activity type has a unique set of movement patterns that can be identified by machine learning algorithms. FIG. 8 shows movement information which has been grouped into distinct groups depending on the z axis acceleration movement information (log of the z axis acceleration) and the likely probability that the activity is correct. In FIG. 8, Reference numeral 210 corresponds to grazing, reference numeral 220 corresponds to walking, reference numeral 230 corresponds to lying, reference numeral 240 corresponds to running, reference numeral 250 corresponds to sleeping, reference numeral 260 corresponds to standing and reference numeral 270 corresponds to urinating.

The ‘relation’ between a sensor value and the animals' behaviour is not always ‘human describable’. Hence machine learning can help in this area. For example, the animal is a bovine (e.g. a cow) there are some relations between sensor values and the bovine behaviour that have been determined:
Pitch: pitch indicates when a bovine is grazing (head goes down)
Roll: roll indicates when a bovine is lying on its side
Overall Dynamic Body Acceleration (ODBA): ODBA indicates how active a bovine is. For example, running, charging, walking, mounting are behaviours where the bovine is very active.

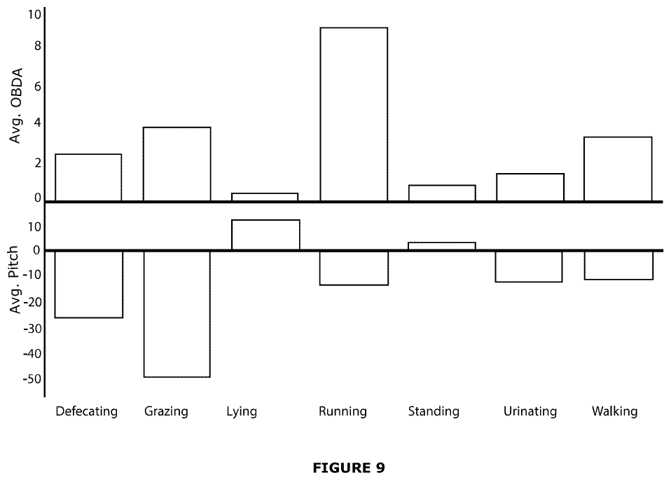

In terms of urinating/defecating behaviour, it is difficult to know when a cow is urinating/defecating based on sensor data captured by a collar on the neck of an animal. However, you can exclude a lot of activity types. For example, based on Roll and ODBA you know when a cow is running, lying on her side, or mounting, and hence it is likely not to be urinating/defecating. Using this information, as well as location, a heat map can be created of where a cow has likely been urinating/defecating. A graph of how pitch and ODBA relate to each behaviour is shown in FIG. 9.

Alternatively, a wearable device may be attached to other limbs of an animal for more accurate or different sensor data to be collected. For example, a wearable device to be worn on the tail of an animal will give very accurate data of urination activity, as the tail of a cow often moves in a particular way when the cow is urinating.

The user 820 can input their desired variables such as the zone boundaries, amendment types, applicator specifications, and desired rates to be achieved into the device 830, or PC 890 for example, to include into the zone map 4 and factor index 11. The zone map 4 will define what area is to be amended, i.e. what area of paddock or land to apply the present invention to. This will normally be a set of waypoints, GPS coordinates or similar. The amendment types will be the type of amendments to be applied, e.g. a urea fertiliser and a urease inhibitor etc. The desired rate will be how much of the fertiliser to be applied, e.g. how many kg of urea fertiliser per hectare. The applicator specifications will include the amendment options, and the granularity and control the applicator 12 has over the application of the amendments. The user, or other expert will determine other information for the factor index 11, such as how the location and time period information of an animal at a location will affect the amendment. E.g. A cow voiding at a location may increase the application of urease inhibitor from 0% at that location to 100%, and decrease the fertiliser application from 100% of the desired rate to 5%. The factor index will comprise the factors that modify the application rate/amount/type, these factors may be able to be changed depending on the farm/user/pasture requirements.

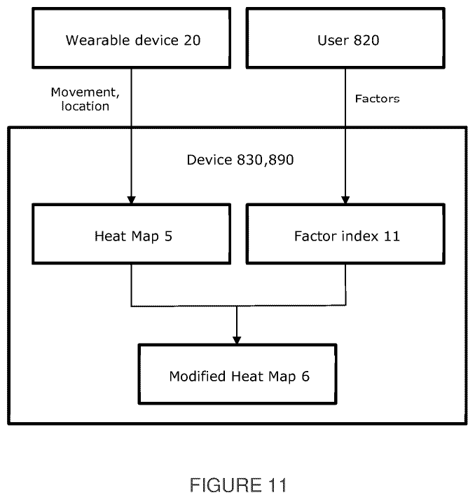

As shown in FIG. 11, the device 830,890 is configured to receive one or both of the movement information and location information from the wearable device. From these inputs, the device 830,890 can then create a modified heat map 6 by calculations with the factor index 11 already loaded into the software application of the device 830,890. The factors of factor index 11 may be at least partially provided by a user 820 and may additionally be accessible and modifiable by the user 820. The modified heat map 6 is then overlaid with the desired zone map 4 by the software of the device 830,890 to create the application map 7. The application map 7 is then able to be sent to, or uploaded to the applicator 12.

The animal is a bovine animal, such as a dairy cow or beef animal. The animal may also be other types of bovine such as oxen, goats, sheep, bison, and buffalo. The present invention can be used with any animal that is located on pasture or crops.

Where the term ‘map’ has been used, the map may be interpreted as a matrix, code, index, algorithm or other appropriate means to collate and transform data.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

What is claimed is:

1. A method of applying an amendment to at least one of crop, pasture and soil within a zone, wherein the method comprises at least the following steps:
a. determining a zone map of the zone which is to have amendment applied to or within, the zone map comprising information on a desired amount of the amendment and/or type of amendment to be applied to said at least one of crop, pasture and soil within the zone,
b. determining at least one of:
i. location information comprising a duration of time spent by at least one animal in a particular location within said zone over a period of time, and
ii. position information corresponding to the activity of at least one animal within said zone at a particular location,
c. processing at least one of the location information and the position information determined from at least one of i and ii and creating a heat map representing at least one of the location information and the position information of said at least one animal,
d. applying a factor index to the heat map to create a modified heat map, the factor index comprising at least one factor to change the amount of the amendment and/or type of amendment to be applied, the modified heat map comprising factors to change said at least one of the location information and the position information into a processed data for determining the amount and/or the type of the amendment to be applied to at least the particular locations in the zone,
e. using modified heat map to create an application map, the application map being used to determine the location, amount, and optionally type, of the amendment to be applied to the particular locations within the zone, and
f. applying the amount and type of amendments to said at least one of crop, pasture and soil dependent on the application map.

2. The method of claim 1, wherein the activity is at least one of urination, defecation, grazing, ruminating, standing, resting, and lying.

3. The method of claim 1, wherein one of the factors in the factor index is configured to increase the amount of amendment depending on the heat map where said at least one animal has spent less time compared to elsewhere within the zone, or has less activity than elsewhere within the zone.

4. The method of claim 1, wherein one of the factors in the factor index is configured to decrease the amount of amendment depending on the heat map where said at least one animal has spent more time compared to elsewhere within the zone, or has more activity than elsewhere within the zone.

5. The method of claim 1, wherein one of the factors in the factor index is configured to select a urease inhibitor as the amendment depending on the heat map where the said at least one animal has spent more time compared to elsewhere within the zone, or has more urination activity than elsewhere within the zone.

6. The method of claim 1, wherein one of the factors in the factor index is configured to select an amendment to decrease negative effects of high nitrogen content caused by said at least one animal's urine and/or excrement.

7. The method of claim 1, wherein the application map is configured to be received by an amendment applicator that is configured to release the amount and/or type of amendment as an amendment output.

8. The method of claim 7, wherein the amendment applicator is a variable rate fertiliser spreader and/or sprayer.

9. A system for applying amendment to the ground of a zone which has been geo-indexed, the system comprising a computer that is configured for operative communication with a plurality of wearable devices each configured to be worn by an animal, the wearable device comprising a processor and a navigation module configured to determine location information consisting of a location of an animal, and the time the animal was at the location, the computer being configured to:
a. receive the location information for said geo-indexed zone from the plurality of wearable devices for a desired time period,
b. process the location information and create a heat map by summing the location information for the geo-indexed locations the plurality of animals are in over the desired time period, and
c. apply a factor index to the heat map to create a modified heat map, the factor index comprising at least one factor to multiply a set amount of amendment, per geo-index location, with the heat map.

10. The system of claim 9, wherein the system comprises a variable rate amendment applicator configured to receive the modified heat map and apply the appropriate amendment to the zone depending on the modified heat map.

11. The system of claim 9, wherein the variable rate amendment applicator comprises a processor and software to receive the modified heat map and control the output of the amendment from a hopper containing the amendment, dependent on the location in the zone the variable rate amendment applicator is in.

12. A system for applying amendment rate for geo-indexed zone, the system comprising a computer configured to receive location information of a plurality of wearable devices each configured to be worn by an animal, the wearable device comprising a processor and a navigation module configured to determine the location information consisting of a location of the animal and a time the animal was at the location, the computer configured to:
a. receive the location information for each geo-index the plurality of animals are in over a desired time period, and
b. apply a factor index to the determined location information of each geo-indexed location to determine an amendment rate, the factor index comprising at least one factor to adjust a set amount of amendment by the location information to determine the amendment rate.

13. The system of claim 12, wherein the location information further comprises activity information relating to the activity the animal was performing in a location, and the amendment rate is determined by applying the factor index to one or both of the location of the animal and activity information.

14. The system of claim 12, wherein the computer is configured to create an application map dependent on the amendment rate per geo-index location, the application map configured to be read by an applicator so the applicator is able to apply amendment at the amendment rate on ground related to the application map.

15. The system of claim 12, wherein the system comprises an amendment applicator configured to apply the amendment rate dependent on the respective geo-index the amendment applicator is in, the amendment applicator comprises a processor and software to receive the amendment rate and control the output of the amendment from a hopper containing the amendment dependent on the geoindex the amendment applicator is located in.

16. A method for determining an amendment rate for a zone, the method comprising
a. providing a plurality of wearable devices each configured to be worn by an animal, the wearable device comprising a processor and a navigation module configured to determine the location information consisting of a location of the animal and a time the animal was at the location,
b. receiving location information for a desired time period, and
c. applying a factor index to the determined location information of each location to determine an amendment rate, the factor index comprising at least one factor to adjust a set amount of amendment by the location information to arrive at the amendment rate.

17. The method of claim 16, wherein the method comprises creating an application map dependent on the amendment rate per location, the application map configured to be read by an applicator so the applicator is able to apply amendment at the amendment rate on ground related to the application map.

18. The method of claim 16, wherein the method comprises applying the amendment to the zone via an amendment applicator configured to apply the amendment rate dependent on the location the amendment applicator is in.

19. The method of claim 16, wherein the zone is geo-indexed and the location information is indexed to the geo-index.
